(19) United States
(12) Patent Application Publication
(10) Pub. No.: US 2009/0297137 A1
(43) Pub. Date: Dec. 3, 2009

(54) OMNI-DIRECTIONAL CAMERA SYSTEM

(76) Inventor: Allan C. Entis, Tel Aviv (IL)

Correspondence Address: Allan C. Entis Ph.D., Intellectual Property Ltd., 6 Raoul Wallenberg Street, Ramat Hachayal, Tel Aviv, 69719, IL

(21) Appl. No.: 12/416,340

(22) Filed: Apr. 1, 2009

(30) Foreign Application Priority Data
Apr. 1, 2008 (GB) GB0805843.0

(51) Int. Cl. G03B 37/00

(52) U.S. Cl. 396/333; 396/428

(57) ABSTRACT

Apparatus operable to change direction of an optic axis of a camera, the apparatus comprising: a sphere configured so that at least one camera is mountable therein and having a region through which light may enter the sphere and be collected by the at least one camera; and at least one motor operable to rotate the sphere about the center of the sphere to orient the optic axis in a desired direction.

### CROSS-REFERENCES TO RELATED APPLICATIONS

The present application claims benefit under 35 U.S.C. §119(a)-(d) of British Application GB0805843.0 filed Apr. 1, 2008, the entire content of which is incorporated herein by reference.

### FIELD OF THE INVENTION

Embodiments of the invention relate to an “omni-directional” camera system operable to orient an optical axis of a camera in a substantially 4π steradian solid angle of directions.

### BACKGROUND

Omni-directional camera systems that are operable to orient a camera to image scenes in a relatively wide range of different directions are relatively common and are used in many different applications. They may be used for example for surveillance and/or alarm systems and for robotic vision.

Generally, these systems comprise an electromagnetic motor coupled to a camera by a relatively complicated transmission system. The motor and transmission system are controllable to point an optic axis of the camera in a relatively wide range of directions so that the camera can image scenes in an extended field of view that is substantially larger than the camera field of view.

U.S. Pat. No. 7,274,805 describes an omni-direction camera system that comprises “a rotary electric machine for horizontally rotating (panning)” a camera. The electric machine is coupled to the camera using a relatively complicated set of shafts and a reduction gear.

U.S. Pat. No. 7,268,819 describes a “scanning camera comprising: an imaging device for capturing an image having an image pickup element, a support shaft attached to the imaging device for changing a photographing direction, a frame for supporting the imaging device through the support shaft, a driver attached to the frame for rotating the imaging device, and a flexible connector electrically connected to the image pickup element and having two planar portions, said two planar portions extending to the frame from at least two positions of the imaging device at opposite sides relative to an axis of the support shaft diagonally away from each other such that the two planar portions of the flexible connector are arranged parallel to the axis of the support shaft.”

Some surveillance and scanning systems use an optical system for providing an extended field of view for a camera. U.S. Pat. No. 7,190,259 descries a surveillance system for use on a mobile body that has an optical system for providing an extended field of view. The system has “an omnidirectional vision sensor comprising an optical system for reflecting light incident from a maximum surrounding 360-degree visual field area toward a predetermined direction and an imaging section for imaging light reflected from the optical system to obtain image data”.

### SUMMARY

An aspect of some embodiments of the invention relate to providing a relatively simple omni-directional camera system operable to orient a camera to image a scene in a relatively large range of different directions.

According to an aspect of some embodiments of the invention, the omni-directional camera system is configured to point an optical axis of a camera comprised in the system in substantially any direction in a solid angle substantially equal to 4π steradians.

An aspect of some embodiments of the invention relates to providing a relatively small omni-directional camera system.

An aspect of some embodiments of the invention relates to providing a relatively simple transmission system for coupling a motor to a camera optionally comprised in an omni-directional camera system so that the motor is operable to change direction of the optic axis of the camera. Optionally, the transmission system couples at least one piezoelectric motor to the camera.

According to an aspect of an embodiment of the invention, the transmission system, hereinafter referred to as a “sphere transmission” system, comprises a sphere that may be rotated through substantially any angle of rotation about substantially any given axis passing through the center of the sphere. Rotation of the sphere about a given axis may be performed by directly rotating the axis about the given axis or by rotating the sphere about a plurality of other axes that result in a rotation of the sphere about the given axis. Optionally, the sphere is friction coupled to at least one piezoelectric motor operable to rotate the sphere about an axis passing through the sphere's center. A camera is mounted inside the sphere so that its optical axis is collinear with the center of the sphere and passes through a region of the surface of the sphere through which light may enter the camera.

In an embodiment of the invention, a support frame having features or comprising elements that contact the surface of the sphere in at least three regions supports the sphere. The support frame is moveable so that coordinates of contact regions relative to a fixed coordinate system having an origin at the center of the sphere may be changed. The contact regions may therefore be changed so that they do not block a direction along which it is desired to point the optic axis of the camera.

For convenience of presentation an omni-directional camera system comprising a sphere transmisison system is referred to as a “Seeing-Eye” camera system.

### BRIEF DESCRIPTION OF THE FIGURES

Examples illustrative of embodiments of the invention are described below with reference to figures attached hereto. In the figures, identical structures, elements or parts that appear in more than one figure are generally labeled with a same numeral in all the figures in which they appear. Dimensions of components and features shown in the figures are generally chosen for convenience and clarity of presentation and are not necessarily shown to scale. The figures are listed below.

FIGS. 1A and 1B schematically show an omni-directional Seeing-Eye camera system, in accordance with an embodiment of the invention; and

FIG. 2 schematically shows an omni-directional Seeing-Eye camera system comprising a sphere transmission system in accordance with an embodiment of the invention.

### DETAILED DESCRIPTION OF EMBODIMENTS

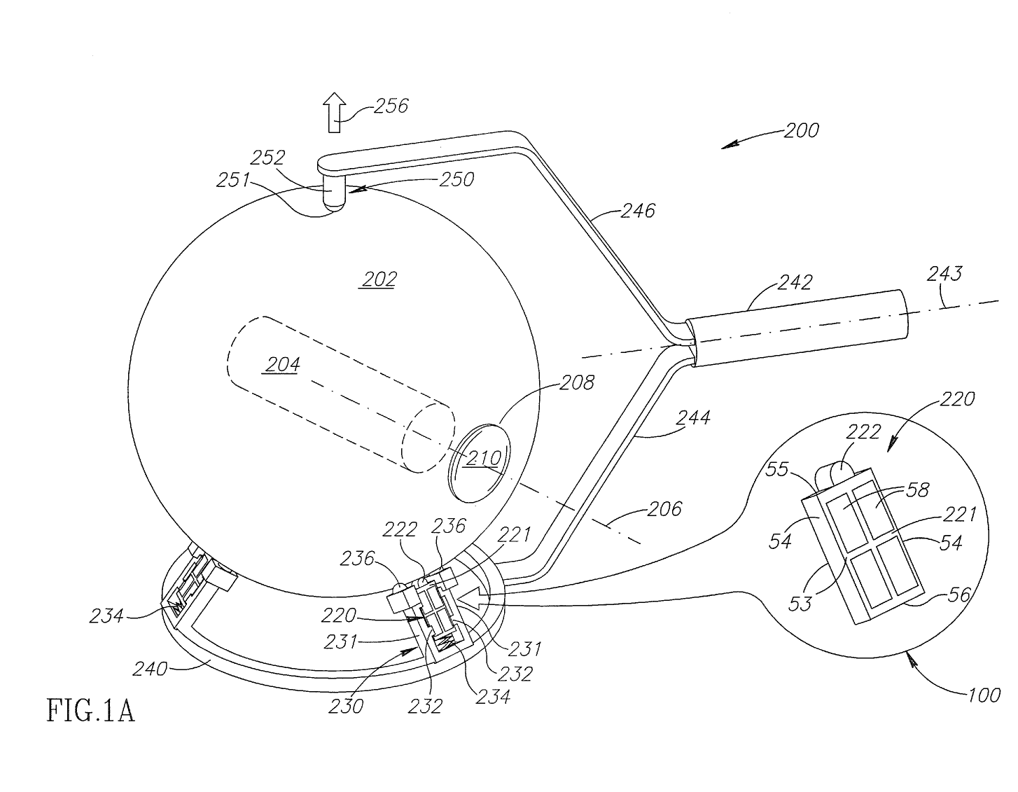

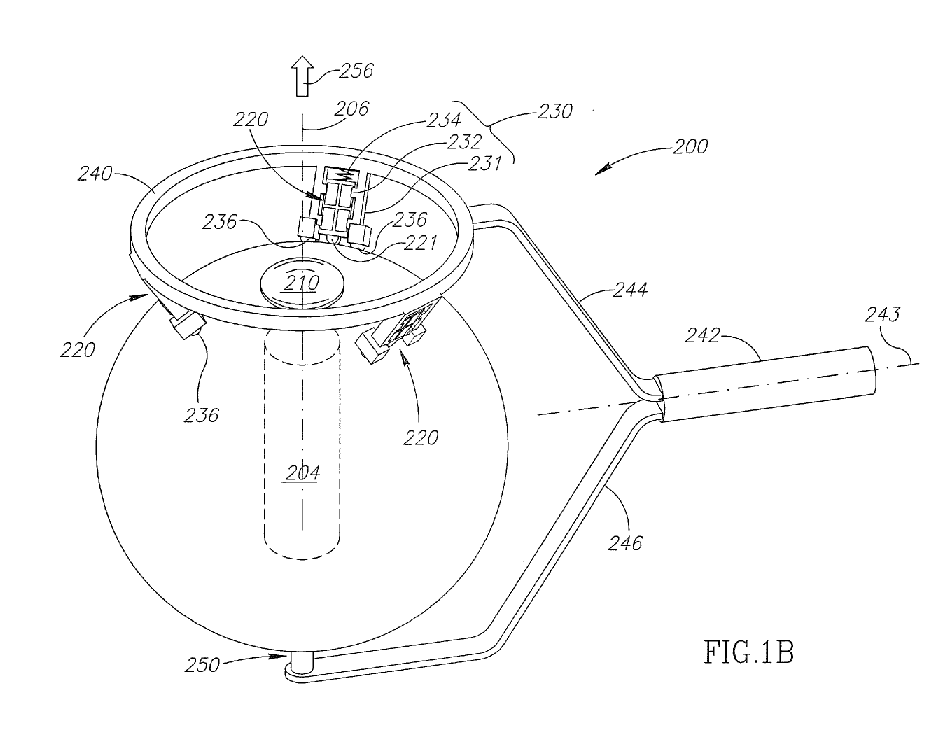

FIGS. 1A and 1B schematically show an omni-directional camera system 200, “a Seeing-Eye camera system 200”, in accordance with an embodiment of the invention.

Seeing-Eye camera system 200 comprises a sphere 202, having mounted inside the sphere a camera 204, shown in dashed lines, having an optic axis 206 optionally collinear with the center of the sphere. Optic axis 206 passes through a region 208 of sphere 202 through which light that camera 204 images passes. Optionally, region 208 comprises a collecting lens that is a component of an optical system of the camera. By way of example, in FIGS. 5A and 5B region 208 is shown having a collecting lens 210 that collects light which camera 204 images.

Camera 204 is mounted inside sphere 202 using any of various methods and devices. For example, assuming sphere 202 is a substantially hollow spherical shell, camera 204 may optionally be held in place by a configuration of struts attached to the camera and an inside wall of the shell. Optionally, the camera is held in place by a lightweight material such as Styrofoam that is shaped to at least partially fill the sphere and hold the camera. If sphere 202 is substantially solid, optionally camera 204 is held in place in a cavity formed in the sphere.

Sphere 202 is optionally supported by at least one piezoelectric motor 220. By way of example, sphere 202 is shown supported by three piezoelectric motors 220, of which only two are shown in FIG. 5A. An inset 100 schematically shows an enlarged view of a motor 220. Optionally, each piezoelectric motor 220 comprise a relatively thin planar piezoelectric vibrator 221 having front and back planar face surfaces 53, relatively long edge surfaces 54 and relatively short top and bottom edge surfaces 55 and 56 respectively. A friction nub 222 that contacts sphere 202 is located on short edge 55 of the motor. Optionally, four quadrant electrodes 58 are located in a symmetric checkerboard pattern on front face surface 53. A single large electrode (not shown) is located on back surface 53. A controller, not shown, electrifies quadrant electrodes 58 to generate vibrations in piezoelectric motor 220 and thereby in friction nub 222 to apply force to sphere 202.

In an embodiment of the invention, at least one motor 220 is controllable to generate vibrations in its friction nub 222 to apply force to sphere 202 selectively in either direction along a tangent to the sphere parallel to the motor's vibrator 221 and in either direction along a tangent to the sphere perpendicular to the vibrator. Motors suitable for the practice of the invention that are controllable to provide such forces are described in U.S. Pat. Nos. 5,453,653, 7,075,211 or 6,384,515, the disclosures of which are incorporated herein by reference. All three motors 220 are shown in FIG. 5B discussed below.

Each piezoelectric motor 220 is optionally held in a “U” shaped motor mounting frame 230, which is fixed to a support ring 240 and has arms 231. U-frames 230 and their piezoelectric motors 220 are optionally symmetrically positioned on support ring 240. The support ring is optionally connected to a beam 242 by a connecting arm 244.

Any of various methods known in the art may be used to mount and hold a piezoelectric motor 220 in its U-frame 230. Optionally, the U-frame has “buttons” 232 that contact and grasp piezoelectric motor 220. A resilient element 234 comprised in U-frame 230 urges piezoelectric motor 220 so that friction nub 221 of the motor presses against sphere 202. Optionally, each arm 231 of a U-frame 230 has a bearing 236 at its end on which sphere 202 is supported that allows the sphere to rotate relatively freely about any axis through the center of the sphere. Bearing 236 may be any type of bearing or configuration of bearing known in the art. Optionally, the bearing is a low friction surface along which sphere 202 is free to slide easily. Optionally, as shown in FIGS. 1A and 1B bearing 236 comprises a single ball bearing 237.

In some embodiments of the invention, an opposing bearing 250 is located on a side of sphere 202 opposite to that contacted by piezoelectric motors 220. Opposing bearing 250 is connected to beam 242 by a connecting arm 246 and operates to apply force to sphere 202 that maintains the sphere pressed against bearings 236 of U-frames 230 and piezoelectric motors 220. Optionally, the force is generated by suitably configuring connecting arms 244 and 246 and providing the arms with appropriate elasticity, and/or by directly spring loading bearing 236 and 250.

Opposing bearing 250 may be any bearing or bearing arrangement known in the art that allows sphere 202 to rotate freely about any axis through the center of the sphere and to be positioned securely seated on bearings 236 of U-frames 220. For example, bearing 250 may comprise a low friction surface along which sphere 202 can relatively easily slide, a single bearing or a plurality of ball bearings held in a suitable bearing housing. In FIGS. 1A and 1B, opposing bearing 250 is shown, by way of example, comprising a single ball bearing 251 held by cylindrical housing 252. Ball bearing 251 has its center coincident with a line (not shown) passing through the center of sphere 202 and a center of support ring 232.

A controller, not shown, controls piezoelectric motors 220 to apply a suitable combination of forces substantially tangent to sphere 202 and parallel to and/or perpendicular to a plane of at least one piezoelectric motor 220 so as to rotate the sphere 202 about any axis through the center of the sphere by a desired angle. The controller can therefore control the motors to orient optic axis 206 of camera 20 along any direction in which it is desired to have the camera acquire an image of a scene.

It is noted that it is possible to have one motor 220 apply force to sphere 202 while the other motors 220 are operated so that they are substantially disengaged from the sphere. A motor 220 is disengaged from the sphere by exciting the motor so that its friction nub 221 vibrates substantially only along a direction perpendicular to the spheres surface. When operated so that its friction nub 221 vibrates perpendicular to the sphere's surface friction between the motors' friction nub and sphere 202 is relatively small and contact of the nub and sphere does not substantially resist motion of the sphere. Piezoelectric motors controllable to selectively vibrate substantially only perpendicular to a surface of a body to which it is coupled to move the body are described in U.S. Pat. No. 7,075,211 referenced above. Methods of disengaging a piezoelectric motor from a load to which it is coupled by exciting the motor to vibrate its friction nub perpendicular to a surface to which the nub is pressed, is described in U.S. Patent Publication 2007138910, the disclosure of which is incorporated herein by reference.

It is noted that for directions in which optic axis 206 intersects or passes near to an element, such as a connecting arm 244 or 246, ring 232 or a motor 220, of the structure supporting sphere 202, the field of view of camera 204 is expected to be at least partially obstructed. For example, in FIG. 1A, if motors 220 are controlled to orient optic axis 206 to point optic in a direction indicated by a block arrow 256, the field of view of camera 202 would at least partially be obstructed by opposing bearing 250.

In accordance with an embodiment of the invention, to enable camera 204 to image a scene that might be obstructed by an element of the support structure of sphere 202, beam 242 is rotatable about an axis 243 of the beam so that the obstructing element can be rotated out of the camera's field of view. For example, to provide an unobstructed field of view for camera 202 in a direction indicated by block arrow 256 beam 242 is optionally rotated by 180°. Following rotation of beam 202, as schematically shown in FIG. 1B the positions of opposing bearing 250 and motors 220 are reversed, with the opposing bearing on the “bottom” and the motors on the top and the field of view in direction 256 is no longer obstructed. Motors 220 may then be controlled to orient sphere 220 so that optic axis 221 points in the direction 256 and camera 204 has an unobstructed view in direction 256. It is of course understood that a rotation of beam 242 about axis 243 by an angle other than 180°, for example, a rotation of 90° or 45°, could of course be used to unclutter the field of view in direction 256.

Beam 242 may be rotated using any of various methods and devices known in the art. In some embodiments of the invention, at least one piezoelectric motor is used to rotate beam 242. Optionally, an electromagnetic motor is used to rotate the beam. Whereas beam 242 in FIGS. 1A and 1B is shown as a single uniform beam, in some embodiments of the invention, beam 242 is articulated so that the beam may be bent about an axis perpendicular to axis 243 and the location of the center of sphere 202 changed.

Whereas in Seeing-Eye camera system 200, three piezoelectric motors 220 are used to orient sphere 202, the present invention is not limited to rotating sphere 202 using three piezoelectric motors that contact the sphere. U.S. Pat. No. 6,284,515, the disclosure of which is incorporated herein by reference, describes a method of rotating a sphere using a single piezoelectric motor in contact with the sphere.

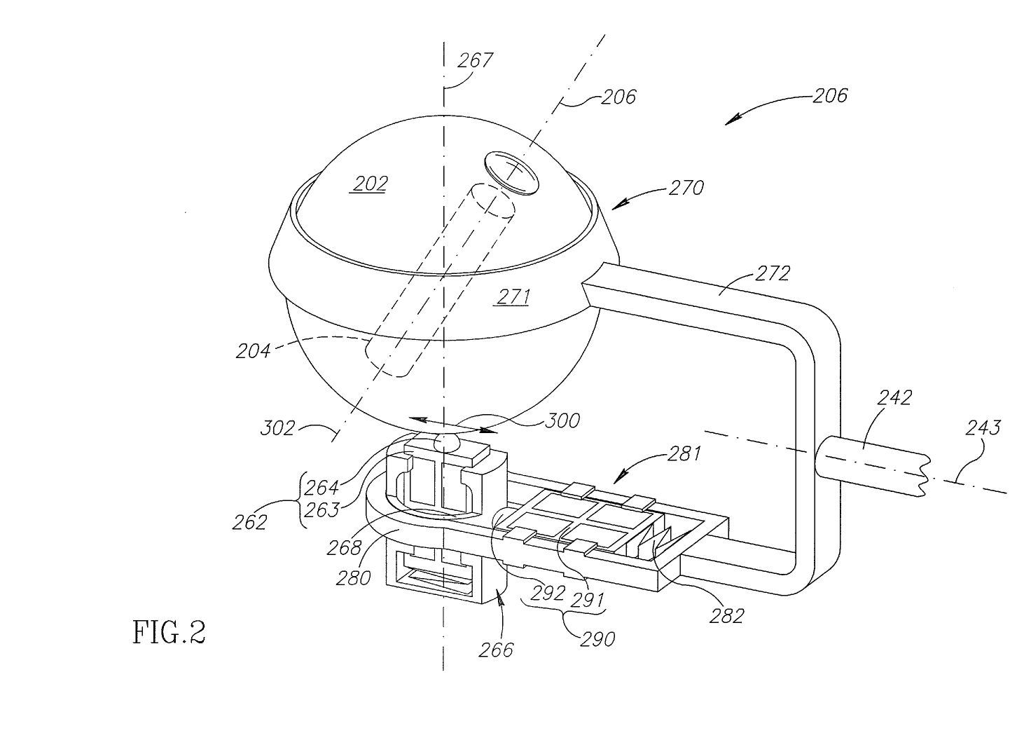

FIG. 2 schematically shows an omni-directional camera system 260 comprising a single piezoelectric “driving” motor 262 in contact with a sphere 202 having a camera 204 mounted inside the sphere. Camera 204 has an optic axis 206 optionally collinear with the center of the sphere. Optionally, driving motor 262 is similar to motors 50 and 60 shown in FIGS. 1A-1D and comprises a relatively thin piezoelectric vibrator 263 having a friction nub 264.

Sphere 202 seats on friction nub 264 of piezoelectric driving motor 262 and is held in place on the friction nub optionally by a support bearing 270, which enables the sphere to rotate freely about any axis through the center of the sphere. Support bearing 270 may be any suitable bearing known in the art and is optionally a ring bearing comprises an annular ball bearing housing 271 comprising a plurality of ball bearings (not shown). An arm 272 optionally connects annular ring housing 271 to a beam 242 rotatable about an axis 243.

Driving motor 262 is optionally mounted inside a rotation frame 266. Rotation frame 266 has an axis of rotation 267 and optionally comprises a rotation collar 268. The rotation collar is held by a bearing collar 280 that extends from a motor mounting frame 281 so that the rotation collar is substantially freely rotatable about axis 267. Motor mounting frame 281 holds a piezoelectric steering motor 290. Steering motor 290 is optionally similar to piezoelectric motors 50 and 60 (FIGS. 1A-1D) and has a piezoelectric vibrator 291 and a friction nub 292. Mounting frame 281 urges piezoelectric motor towards rotation collar 268 so that friction nub 291 resiliently presses against the collar. Any method known in the art may be used to resiliently press steering motor 290 to collar 268. Optionally, as shown in FIG. 2, mounting frame 281 comprises a spring 282 that urges the motor to the collar.

In an embodiment of the invention, driving motor 262 is controllable to apply force to rotate sphere 202 selectively in either direction along a tangent, schematically indicated by a double arrowhead line 300, to the sphere at the region where the sphere contacts friction nub 264, which tangent is parallel to piezoelectric vibrator 263. Depending on its direction along tangent 300, the force rotates sphere 202 clockwise or counterclockwise about a rotation axis 302 that passes through the center of the sphere and is perpendicular to tangent 300 and axis 267.

Steering motor 290 is controllable to rotate rotation collar 268 and thereby piezoelectric motor 262 about axis 267 so that tangent 300 and therefore axis of rotation 302 points in any desired direction perpendicular to axis 267. Driving motor 262 is then controllable to rotate sphere 202 clockwise or counterclockwise about rotation axis 302. A suitable controller, not shown, controls steering motor 290 to rotate driving motor 262 about axis 267 and motor 262 to rotate sphere 202 about rotation axis 302 through appropriate angles to point optic axis 206 in any desired direction. As in Seeing-Eye camera 200, beam 242 is rotatable to provide camera 204 with a clear field of view in substantially any direction.

It is noted that the above configurations of a Seeing-Eye camera in accordance with an embodiment of the invention, comprise a support structure for supporting a sphere, which has a bearing configuration opposed by an opposing bearing or a piezoelectric motor. The opposing bearing or piezoelectric motor applies a force to the sphere that aids in maintaining the sphere seated in the bearing configuration. Practice of the invention is not limited to any particular support structure for holding a sphere so that it is rotatable about axes that pass through the sphere's center. For example, in some embodiments of the invention, a Seeing-Eye camera does not comprise an opposing bearing or opposing piezoelectric motor that applies a force that operates to seat the sphere in a bearing configuration. Optionally, the sphere of the camera rests and is held in place on an at least one piezoelectric motor and/or a suitable bearing configuration by gravity. Optionally, the sphere is held in place by magnetic force between the sphere and a suitable permanent or electromagnet magnet. For example, the sphere is optionally held in place by magnetic force between a magnet and magnetic moment induced in material of the sphere by the field of the magnet.

It is further noted that whereas in the described embodiments of the invention the camera mounted in the sphere has an optic axis collinear with the sphere center, in some embodiments of the invention the camera may have an optic axis displaced from the sphere center. It is also noted that in some embodiments of the invention a Seeing-Eye camera may comprise more than one camera mounted inside a sphere. For example a Seeing-Eye camera, in accordance with some embodiments of the invention, comprises two cameras mounted inside a sphere. Optionally, the cameras have their optic axes parallel and are displaced one from the other to provide binocular vision and depth perception.

In the description and claims of the present application, each of the verbs, “comprise” “include” and “have”, and conjugates thereof, are used to indicate that the object or objects of the verb are not necessarily an exhaustive listing of members, components, elements or parts of the subject or subjects of the verb.

The invention has been described with reference to embodiments thereof that are provided by way of example and are not intended to limit the scope of the invention. The described embodiments comprise different features, not all of which are required in all embodiments of the invention. Some embodiments of the invention utilize only some of the features or possible combinations of the features. Variations of embodiments of the described invention and embodiments of the invention comprising different combinations of features than those noted in the described embodiments will occur to persons of the art.

1. Apparatus operable to change direction of an optic axis of a camera, the apparatus comprising:
a sphere configured so that at least one camera is mountable therein and having a region through which light may enter the sphere and be collected by the at least one camera; and
at least one motor operable to rotate the sphere about the center of the sphere to orient the optic axis in a desired direction.

2. Apparatus according to claim 1, wherein the optic axis of the camera is collinear with the center of the sphere.

3. Apparatus according to claim 1, wherein the at least one camera comprises two cameras.

4. Apparatus according to claim 3, wherein the cameras have their optic axes parallel.

5. Apparatus according to claim 3, wherein the cameras are displaced one from the other to provide binocular vision and depth perception.

6. Apparatus according to claim 1, and comprising a support structure that holds the sphere.

7. Apparatus according to claim 6, wherein the support structure comprises at least one bearing on a first side of a great circle of the sphere.

8. Apparatus according to claim 7, wherein the support structure comprises at least one second bearing on a second side of the great circle opposite the first side.

9. Apparatus according to claim 6, wherein the support frame is rotatable about an axis that passes through the center of the sphere.

10. Apparatus according to claim 1, wherein the at least one motor comprises at least one piezoelectric motor.

11. Apparatus according to claim 10, wherein the at least one piezoelectric motor comprises a plurality of piezoelectric motors.

12. Apparatus according to claim 10, wherein the at least one piezoelectric motor comprises a piezoelectric motor coupled to the sphere and operable to apply force to the sphere selectively along at least two orthogonal directions.

13. Apparatus according to claim 10, wherein the at least one piezoelectric motor comprises a first piezoelectric motor coupled to the sphere and operable to rotate the sphere and a second piezoelectric motor operable to rotate the first piezoelectric motor to change a direction in which the sphere is rotated.
